(19) United States
(12) Patent Application Publication
(10) Pub. No.: US 2026/0295352 A1
(43) Pub. Date: Oct. 1, 2026

(54) Enforcer Whistle

(71) Applicants: Demetrice Phillips, Elgin, SC (US); Antwuan Jacobs, Columbia, SC (US)

(72) Inventors: Demetrice Phillips, Elgin, SC (US); Antwuan Jacobs, Columbia, SC (US)

(21) Appl. No.: 19/089,237

(22) Filed: Mar. 25, 2025

(51) Int. Cl. A63B 63/08; H05B 47/105; H05B 47/175; H05B 47/19

(52) U.S. Cl. CPC A63B 63/083; H05B 47/105; H05B 47/19; H05B 47/198; A63B 2225/50; A63B 2225/74; H05B 47/196

(57) ABSTRACT

The present invention is a system and devices for activating lights on a basketball backboard or other selected location when a referee blows their whistle to alert players in a high noise environment of the blown whistle, it is also helpful to players who may be hearing impaired. The detection and transmitting device is incorporated onto a lanyard worn by the referee. The lanyard device sends a digital signal to the Control Board which in turn activates lights on the basketball backboard or other selected location to visually alert players of a blown whistle.

### CROSS REFERENCE TO RELATED APPLICATIONS

None

### STATEMENT REGARDING FEDERALLY SPONSORED RESEARCH OR DEVELOPMENT

This invention was not made by an agency of the United States Government nor under a contract with an agency of the United States Government.

### THE NAME OF THE PARTIES TO JOINT RESEARCH AGREEMENT

Not Applicable.

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable

### BACKGROUND OF THE INVENTION

### Field of the Invention

Referees in many sports use whistles to signal the start and stop of play including basketball, soccer, football, and ice hockey. There are times when players are unable to clearly hear the sound of the whistle, whether this is due to a player's impaired hearing or the noise from spectators. Also, in youth leagues for basketball and soccer for example, where there are multiple courts or pitches in one location with multiple games proceeding simultaneously, it can be difficult for the players to distinguish between whistles for their game or for another game.

The present invention offers a practical and scalable solution for implementing visual signaling in sporting events, especially in multi-court basketball or multi-pitch games. The invention provides a visual signal to alert players of a blown whistle.

The invention combines light emitting diode (LED) technology and wireless communications to provide a visual signal when a referee blows their whistle. The invention is intended to enhance clarity and reduce confusion for players, referees, and spectators. The design of the invention prioritizes modularity, energy efficiency, and ease of use, making it adaptable to various sporting venues and applications.

### Description of Related Art

Published patent application (US 2017/0193764 A1) for the Electronic Whistle Sensor with Microcontroller involves utilizing vibration detection to illuminate a whistle when it has been blown during a sporting event or other activities where a whistle might be used.

Published patent application (US 2024/0149138 A1) for Methods, Devices, and Systems for Facilitating Officials During a Sporting Event involves the referee wearing a device on their belts that can transmit a signal to stop the game clock either upon manual activation or detection of a whistle. A microphone is connected to the device via a cable.

### BRIEF SUMMARY OF THE INVENTION

The present invention is a system and devices for activating lights on a basketball backboard or other selected location when a referee blows their whistle to alert players in a high noise environment of the blown whistle, it is also helpful to players who may be hearing impaired.

The detection and transmitting device is incorporated onto a lanyard worn by the referee. The lanyard device sends a digital signal to the Control Board which in turn activates lights on the basketball backboard or other selected location to visually alert players of a blown whistle.

### BRIEF DESCRIPTION OF THE SEVERAL VIEWS OF THE DRAWING

FIG. 1 shows a simple flowchart of the operation of the system for a basketball game.

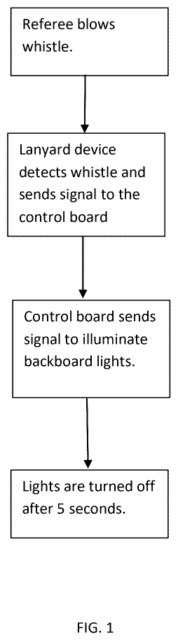

FIG. 2 shows a referee (1) where the sound of the whistle (2) is received by the lanyard device (3) which in turns transmits a digital signal (4) to the control board.

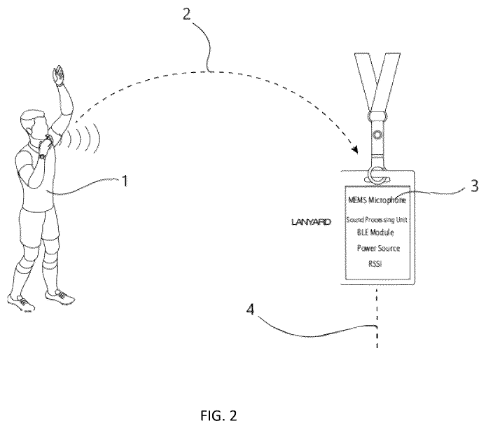

FIG. 3 illustrates the embodiment of LED lights (9) placed on a basketball backboard (8).

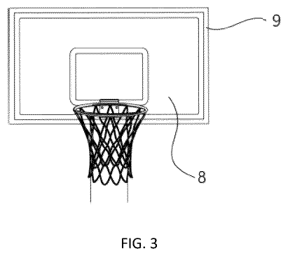

### DETAILED DESCRIPTION OF THE INVENTION

The present invention is a system and device for providing a visual signal to players when the referee blows their whistle to indicate a stoppage of play. The device consists of three parts, each with their own components. The three parts are the lanyard device (3), the Control Board (5) and the lights (9). The preferred embodiment of the invention is tailored to the sport of basketball although the invention could be used for other sports with some minor modifications.

The lanyard device (3) has five basic components/functions: a microphone (3a), a sound processing unit (3b), a signal strength evaluator (3c), a digital signal transmitter (3d), and a power source(3e). The lanyard device (3) components are contained within a small, lightweight case that is affixed to a lanyard worn by the referee.

In the preferred embodiment of the invention, a Micro-Electro-Mechanical Systems (MEMS) microphone (3a) is used to capture the sounding of the referee's whistle. MEMS microphones are preferably used as they are compact, lightweight and highly sensitive to sound frequencies in a whistle's frequency range. MEMS microphones are also resistant to environmental interferences, such as vibrations or motions from the referee's movement on the court.

Although the MEMS microphone is used as the preferred embodiment of the invention, alternative embodiments may use an Electret Condenser Microphone.

The Sound Processing Unit (3b) has two basic components: an analog-to-digital converter(ADC) and a digital signal processor (DSP) or microcontroller. The ADC of the Sound Processing Unit (3b) converts the analog sounds captured by the microphone (3a) into a digital signal. The DSP/microcontroller analyzes digital signal data using Fast Fourier Transform (FFT) algorithms to isolate the whistle frequency from background noises.

The microcontroller also performs signal strength evaluation (3c). The microcontroller uses a Received Signal Strength Indicator (RSSI) measurement to evaluate the strength of the signal received by the microphone to aid in filtering out other referee's whistles or background noises. The whistle closest to the microphone will have a stronger signal.

In the preferred embodiment of the invention, a Bluetooth Low Energy (BLE) module is utilized for digital signal transmission (3d). The BLE enables the lanyard device to send a signal to the control board that the referee wearing that particular device has blown their whistle.

In the preferred embodiment of the invention, the lanyard device (3) is powered by a rechargeable lithium ion battery. However, the invention is not limited to this singular type of power source as other rechargeable or disposable batteries may be used in other embodiments of the invention.

Additional embodiments of the invention may include a haptic feedback device for the referee to know when a signal was successfully transmitted and/or lights on the lanyard device (3) casing to provide device status, such as battery level, Bluetooth connectivity, or whistle detection confirmation. Another feature is BLE-enabled firmware updates to allow software enhancements for example, improving whistle detection algorithms or battery efficiency.

The preferred embodiment of the Control Board (5) has the following components/functions: a digital signal receiver (5a), a microcontroller/processor (5b) to interpret the received signal and trigger the LED lights (9), a LED control circuit (5c), and a power supply (5d).

The digital signal receiver (5a) in the preferred embodiment of the invention is a Bluetooth Low Energy (BLE) receiver comprised of a Bluetooth antenna and a BLE-enabled microcontroller, such as an ESP32 microcontroller.

A microcontroller/processor (5b) is used to evaluate the received Bluetooth signal and execute the required logic to ensure the correct LED lights are triggered. While it is anticipated that the controller upon receiving the required signal will turn on the LED lights and then shut them off after a programmed time period has elapsed, other patterns such as flashing lights could be configured into the controller. In the case of various color or flashing patterns, Pulse Width Modulation (PLW) would be utilized.

The Control Board (5) would be powered by a stable direct current power source. This could be from an electrical cable or a battery system.

The above paragraphs describe the preferred embodiment of the Control Board (5); however, the Control Board (5) is not limited to only the functions described above. Other embodiments of the invention could include an interface, for example a liquid crystal display (LCD) screen or LED indicators to display system status; a Wi-Fi module for remote diagnostics and firmware updates; or a sound generation module to provide audible feedback that an activation signal has been received.

The third part of this invention system is the LED lights (9) that are activated when a referee blows their whistle. The preferred embodiment of this invention is used for a basketball court wherein addressable LED light strips, such as WS2811 or WS2812 LED strips, are affixed to the backboards (8) of the basketball court generally by adhesive backing. The addressable LED light strips integrates a microcontroller that processes signals from the Control Board (5), this allows for advanced programming to create custom lighting effects, such as color coding, and flashing patterns. In the simplest version of this invention, the LED lights would be illuminated upon a whistle signal being received by the controlled board and then extinguished after a set period of time such as 5 to 60 seconds.

Power for the LED system component could be via a 12V DC adapter or a rechargeable battery pack.

The preferred embodiment of this invention is tailored for the sport of basketball, however the invention can by utilized for other sports with some minor modification. For example, the invention could be used for hockey or soccer with the lights affixed to the frame supporting the goal net or for football with the lights affixed to the goal posts.

Suggested classifications for this invention:
A63B 71/06 Indicating or scoring devices for games or players;
A63B 2225/50 Wireless data transmission

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated elements, and/or components, but do not preclude the presence or addition of one or more other elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The invention claimed is:

1. A system for visually alerting a basketball player of a blown referee's whistle consisting of a microphone and signal transmitting device affixed to a lanyard worn by the referee, a control board, and lights affixed to the basketball backboard;
where said device affixed to the lanyard consists of a microphone, an analog to digital converter, a digital signal processor, a Bluetooth Low Energy module that transmits a digital signal, and a power source;
where said control board consists of a Bluetooth Low Energy receiver and a microcontroller/processor;
and where said lights affixed to the basketball backboard are light emitting diodes.

2. The lanyard device of claim 1, where said microphone is a Micro-Electro-Mechanical Systems (MEMS) microphone or an Electret Condenser Microphone.

3. The lanyard device of claim 1, where said power source is a rechargeable lithium ion battery.

4. The control board of claim 1, where said control board also includes a visual interface display.

5. The control board of claim 1, where said control board is WiFi enabled.

6. The lights affixed to the basketball backboard of claim 1, where said lights are addressable light emitting diodes.

7. A system for visually alerting a soccer or hockey player of a blown referee's whistle consisting of a microphone and signal transmitting device affixed to a lanyard worn by the referee, a control board, and lights affixed to the frame supporting the goal net;
where said device affixed to the lanyard consists of a microphone, an analog to digital converter, a digital signal processor, a Bluetooth Low Energy module that transmits a digital signal, and a power source;
where said control board consists of a Bluetooth Low Energy receiver and a microcontroller/processor;
and where said lights affixed to the frame supporting the goal net are light emitting diodes.

8. The lanyard device of claim 7, where said microphone is a Micro-Electro-Mechanical Systems (MEMS) microphone or an Electret Condenser Microphone.

9. The lanyard device of claim 7, where said power source is a rechargeable lithium ion battery.

10. The control board of claim 7, where said control board also includes a visual interface display.

11. The control board of claim 7, where said control board is WiFi enabled.

12. The lights affixed to the frame supporting the goal net of claim 7, where said lights are addressable light emitting diodes.

13. A system for visually alerting a football player of a blown referee's whistle consisting of a microphone and signal transmitting device affixed to a lanyard worn by the referee, a control board, and lights affixed to the goal posts;
where said device affixed to the lanyard consists of a microphone, an analog to digital converter, a digital signal processor, a Bluetooth Low Energy module that transmits a digital signal, and a power source;
where said control board consists of a Bluetooth Low Energy receiver and a microcontroller/processor;
and where said lights affixed to the basketball backboard are light emitting diodes.

14. The lanyard device of claim 13, where said microphone is a Micro-Electro-Mechanical Systems (MEMS) microphone or an Electret Condenser Microphone.

15. The lanyard device of claim 13, where said power source is a rechargeable lithium ion battery.

16. The control board of claim 13, where said control board also includes a visual interface display.

17. The control board of claim 13, where said control board is WiFi enabled.

18. The lights affixed to the goal posts of claim 13, where said lights are addressable light emitting diodes.
